(19) United States
(12) Patent Application Publication
(10) Pub. No.: US 2016/0047457 A1
(43) Pub. Date: Feb. 18, 2016

(54) SHAFT SUPPORTING STRUCTURE OF BELT-DRIVEN CONTINUOUSLY VARIABLE TRANSMISSION

(71) Applicant: TOYOTA JIDOSHA KABUSHIKI KAISHA, Aichi (JP)

(72) Inventors: Motoki TABUCHI, Toyota-shi (JP); Naoyuki SHIBATA, Toyota-shi (JP); Akira IJICHI, Toyota-shi (JP); Kazuya ARAKAWA, Toyota-shi (JP)

(73) Assignee: Toyota Jidosha Kabushiki kaisha, Toyota-shi, Aichi (JP)

(21) Appl. No.: 14/779,250

(22) PCT Filed: Dec. 4, 2013
(86) PCT No.: PCT/JP2013/082542

§ 371 Date: Sep. 22, 2015

(30) Foreign Application Priority Data
Mar. 27, 2013 (JP) 2013-065555

(51) Int. Cl. F16H 57/021; F16H 57/035; F16H 55/56

(52) U.S. Cl. CPC F16H 57/021; F16H 55/56; F16H 57/035

(57) ABSTRACT

A shaft supporting structure of a belt-driven continuously variable transmission for reducing a length of a shaft on which a torque cam is mounted is provided. A first bearing is interposed between an outer circumferential face of the rotary shaft and an inner circumferential face of the torque cam to support those members while allowing relative rotation therebetween. A second bearing is situated radially outside of the first bearing to support one of axial ends of the output member while allowing the output member to rotate relatively with a casing. A sealing member is fitted onto the torque cam to be interposed between an outer circumferential face of the torque cam and the second bearing.

### TECHNICAL FIELD

The present invention relates to a shaft supporting structure of a belt-driven continuously variable transmission in which a torque transmitting capacity is changed in accordance with a belt clamping pressure, and more particularly to a shaft supporting structure of a belt-driven continuously variable transmission that can reduce deformation of a shaft by a load applied from the belt.

### BACKGROUND ART

Japanese Patent Laid-Open No. 2001-330089 describes a belt-driven continuously variable transmission in which a belt is clamped by a thrust force applied from a hydraulic actuator. In the belt-driven continuously variable transmission, one end of an input shaft is hollowed out to which a rotary shaft integrated with a carrier of a torque reversing device is inserted. Power of the torque reversing device is transmitted to the input shaft through teeth on an inner face of the hollow portion and teeth on an outer face of the rotary shaft meshing with each other. Other end of the output shaft is splined to an output gear. Specifically, clearance is maintained sufficiently between a tooth tip and a tooth root of the teeth of the input shaft and the carrier, and a radial clearance is also maintained sufficiently on a spline connecting the output shaft and the carrier. For these reasons, a flexural deformation of the input shaft and the output shaft is tolerated while restricting tilting of the carrier and the output gear.

Japanese Patent Laid-Open No. 2011-226646 describes a belt-driven continuously variable transmission in which an input shaft and an output shaft are basically supported at both ends by two bearings. According to the teachings of Japanese Patent Laid-Open No. 2011-226646, a bearing supporting an end portion of the input shaft of a primary pulley side is disposed in such a manner to be overlapped with a fin disposed on a back side of a fixed sheave.

Japanese Patent Laid-Open No. 61-079061 also describes a belt-driven continuously variable transmission in which a secondary pulley is connected to a torque cam adapted to generate a clamping. Specifically, the secondary pulley comprises: a fixed sheave integrated with an output shaft; a movable sheave opposed to a fixed sheave while being allowed to move axially toward the fixed sheave when connected to the output shaft through a ball key to transmit a torque therebetween; and the torque cam pushing the movable sheave toward the fixed sheave according to an input torque. In the belt-driven continuously variable transmission taught by Japanese Patent Laid-Open No. 61-079061, the output shaft and the torque cam are supported by the bearings in such a manner to rotate with respect to a casing. The output shaft is also supported by another bearing arranged concentrically with the bearing supporting the torque cam along a common axis.

Japanese Patent Laid-Open No. 05-118396 also describes a belt-driven continuously variable transmission in which a primary pulley is provided with a torque cam. According to the torque cam mechanism taught by Japanese Patent Laid-Open No. 05-118396, torque cam grooves are formed on a cylindrical sleeve fitted onto an input shaft, and torque pins individually fitted into the torque cam groove are arranged in a boss portion of a fixed sheave that is arranged around an outer face of the sleeve. The movable sheave is pushed toward a fixed sheave by a load resulting from a reciprocating motion of the torque pin along the torque cam groove achieved by rotating the movable sheave. In order to lubricate a contact portion between the torque cam groove and the torque pin, oil is applied to a clearance between the boss portion and the sleeve. In addition, a bearing supporting the torque cam is arranged concentrically with an oil sealing member.

As described, the belt-driven continuously variable transmission taught by Japanese Patent Laid-Open No. 2001-330089 is adapted to prevent tilting of the member to which power is transmitted from the input shaft or the output shaft meshed therewith while allowing flexural deformation of the input shaft and the output shaft. However, if the sheave is formed integrally with the input shaft or the output shaft, a speed ratio may be changed by a tilting of the sheave to widen a belt groove of the pulley resulting from flexural deformation of the input shaft and the output shaft. Otherwise, the belt may be contacted unevenly with pulley faces.

In the aforementioned belt-driven continuously variable transmissions described in Japanese Patent Laid-Open Nos. 2011-226646 and 05-118396, at least one of the bearings supporting the input shaft or the output shaft is overlapped with other member in the axial direction to reduce a distance between a point of the input shaft or the output shaft to which a load is applied and the bearing, and hence flexural strength of the input shaft or the output shaft is improved. However, even though a position of the bearing is adjusted to shorten the distance from the point of the input shaft or the output shaft to which a load is applied, the input shaft and the output shaft should be deflected at least. As a result, larger part of the shaft has to be situated axially outer side of each bearing and such portion may be deformed easily in the radial direction.

### DISCLOSURE OF THE INVENTION

The present invention has been conceived noting the foregoing technical problems, and it is therefore an object of the present invention is to provide a shaft supporting structure of belt-driven continuously variable transmission that is adapted to shorten a length of a rotary shaft on which a torque cam is disposed so as to prevent a flexural deformation of the rotary shaft by a load derived from a tension of a belt.

A shaft supporting structure of belt-driven continuously variable transmission comprises: a pulley comprising a fixed sheave integrated with a rotary shaft, and a movable sheave fitted onto the rotary shaft while being allowed to reciprocate in an axial direction; a belt running on the pulley; a torque cam fitted onto the rotary shaft on a back side of the movable sheave while being allowed to rotate relatively therewith to generate an axial thrust force in accordance with a torque applied thereto; and an output member fitted onto the torque cam in such a manner to be rotated integrally with the torque cam. In order to achieve the above-explained objective, according to one aspect of the present invention, the shaft supporting structure is characterized by: at least one first bearing interposed between an outer circumferential face of the rotary shaft and an inner circumferential face of the torque cam to support those members while allowing relative rotation therebetween; a second bearing that is situated radially outside of the first bearing to support one of axial ends of the output member while allowing the output member to rotate relatively with a casing; and a sealing member fitted onto the torque cam to be interposed between an outer circumferential face of the torque cam and the second bearing.

The bearing includes a third bearing and a fourth bearing arranged coaxially in series, and any one of the third bearing and the fourth bearing is overlapped with the output member in the axial direction.

The fixed sheave includes a depression in a back face of a pulley face contacted to the belt in which a most inner circumferential side is depressed toward the belt deeper than an outer circumferential side, and a first cylindrical portion that protrudes from the back face in the axially opposite direction to the belt. The shaft supporting structure is further characterized by a fifth bearing situated in an inner circumferential side of the first cylindrical portion while allowing the rotary shaft to rotate relatively with the casing.

As described, the shaft supporting structure of a belt-driven continuously variable transmission comprises: the pulley comprising a fixed sheave integrated with a rotary shaft, and a movable sheave fitted onto the rotary shaft while being allowed to reciprocate in an axial direction; the belt running on the pulley; the torque cam fitted onto the rotary shaft on a back side of the movable sheave while being allowed to rotate relatively therewith to generate an axial thrust force in accordance with a torque applied thereto; and the output member fitted onto the torque cam in such a manner to be rotated integrally with the torque cam. According to another aspect of the present invention, the shaft supporting structure is characterized by: a sixth bearing supporting an end portion of the rotary shaft of the fixed sheave side while allowing the rotary shaft to rotate relatively with the casing; a seventh bearing fitted onto the torque cam to allow the torque cam to rotate relatively with the casing; and at least an eighth bearing and a ninth bearing interposed between an inner circumferential face of the torque cam and an outer circumferential face of the rotary shaft to support those members while allowing relative rotation therebetween. According to another aspect of the present invention, the eighth bearing is disposed between the sixth bearing and the seventh bearing in the axial direction, and the ninth bearing is disposed on an opposite side of the eighth bearing in the axial direction across the seventh bearing.

Specifically, the eighth bearing is overlapped with the output member in the axial direction.

Specifically, the fixed sheave includes a depression in a back face of a pulley face contacted to the belt in which a most inner circumferential side is depressed toward the belt deeper than an outer circumferential side, and a second cylindrical portion that protrudes from the back face in the axially opposite direction to the belt. The shaft supporting structure according to another aspect of the present invention is further characterized by a sixth bearing situated on an inner circumferential side of the second cylindrical portion.

The shaft supporting structure according to another aspect of the present invention is further characterized by an engaged portion that restricts the deformation of the torque cam in a radial direction.

Thus, according to the present invention, the first bearing is interposed between the outer circumferential face of the rotary shaft integrated with the fixed sheave and the inner circumferential face of the torque cam to support a fixed shaft and the torque cam while allowing relative rotation therebetween. The second bearing is situated in the radially outer circumferential side of the first bearing to support the output member rotatably with respect to the casing. In addition, the sealing member is interposed between the outer circumferential face of the torque cam and the second bearing. Therefore, the first bearing, the second bearing and the predetermined member may be overlapped in the axial direction to reduce a length of the rotary shaft and the torque cam. Consequently, flexural deformation of the rotary shaft and the torque cam by a load applied from the belt to the pulley can be suppressed.

As described, one end of the rotary shaft of the fixed sheave side is supported by the sixth bearing, the outer circumferential face of the torque cam is supported by the seventh bearing, and the torque cam and the rotary shaft are supported rotatably by the eighth and the ninth bearing. The eighth bearing is situated between the sixth and the seventh bearings, and the ninth bearing is disposed on the opposite side to the eighth bearing across the seventh bearing. Accordingly, flexural strength of the shaft between the sixth and the eighth bearing can be improved. As a result, deformation of the rotary shaft and the torque cam in the radial direction by a load applied from the belt can be restricted.

According to the present invention, one of the bearings disposed between the outer circumferential face of the rotary shaft and the inner circumferential face of the torque cam to rotatably support those members is overlapped with the output member in the axial direction to reduce lengths of the rotary shaft and the torque cam. For this reason, it is possible to suppress uneven contact between the output member and the torque cam resulting from radial deformation of the rotary shaft and the torque cam caused by the load from the belt.

Optionally, the shaft supporting structure may comprise the depression formed on the back face of the fixed sheave, the cylindrical portion protruding from the back face of the fixed sheave to the axial direction, and the bearing for supporting the rotary shaft at the inner circumferential side of the cylindrical portion. Accordingly, the length of the rotary shaft and the torque cam can be reduced.

In addition, the engaged portion for restricting the radial deformation of the torque cam may be arranged in the output member. Therefore, deformation of the rotary shaft and the torque cam in the radial direction by a load from the belt can be suppressed.

### BRIEF DESCRIPTION OF THE DRAWINGS

FIG. 1 is an explanatory illustration showing an example of the shaft supporting structure of belt-driven continuously variable transmission according to the present invention.

FIG. 2 is an explanatory illustration showing an example of a structure for restricting displacement of the shaft member of output side of the bearing.

FIG. 3 is an explanatory illustration showing an example of a structure in which the bearing interposed between the torque cam and the rotary shaft member is arranged between the bearings supporting the shaft member.

FIG. 4 is an explanatory illustration showing one example of the structure in which a moment derived from a load of a belt applied to a shaft member is decreased to restrict flexural deformation of the shaft member.

FIG. 5 is an explanatory illustration showing a structure for preventing scattering of lubrication oil leaking from the bearing toward an outer circumferential side of a fixed sheave.

FIG. 6 is a skeleton diagram showing one example of a structure of a powertrain having the belt-driven continuously variable transmission to which the present invention is applied.

### DETAILED DESCRIPTION OF THE PREFERRED EMBODIMENT(S)

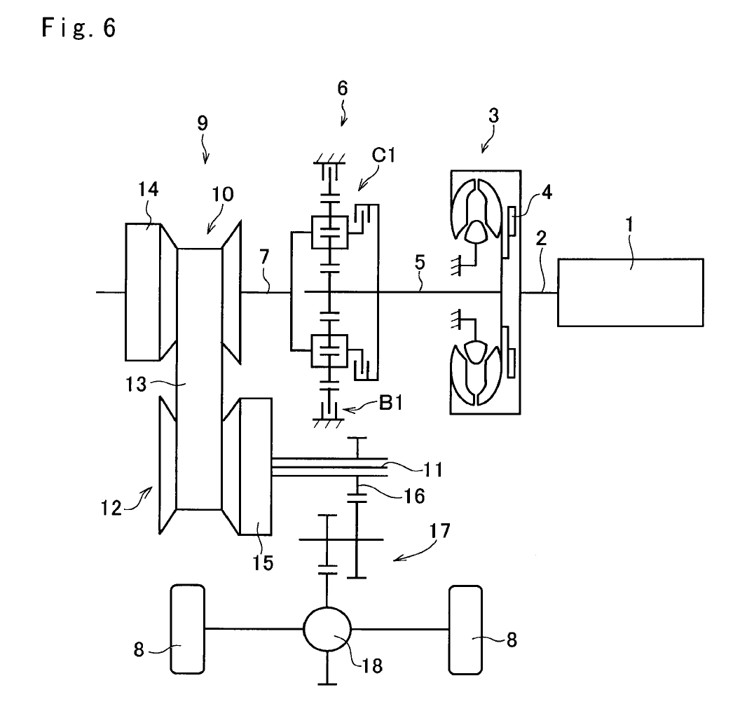

A powertrain having a belt-driven continuously variable transmission to which the present invention is applied will be described hereinafter. FIG. 6 is a skeleton diagram showing one example of the powertrain. The powertrain shown in FIG. 6 comprises a prime mover 1 such as and engine and a motor. Optionally, a hybrid drive unit having both of an engine and a motor may also be used as the prime mover 1. Here, in the example to be explained, the engine 1 is employed as a prime mover.

An output shaft 2 of the engine 1 is connected to a torque converter 3. As known in the conventional art, the torque converter 3 is adapted to transmit power through a spiral flow while multiplying the torque within a converter range where an input speed is higher than an output speed. The torque converter 3 is equipped with a lockup clutch 4 adapted to directly transmit torque when brought into engagement.

In the example shown in FIG. 6, a torque reversing device 6 is connected to an output shaft 5 of the torque converter 3. As also known in the conventional art, the torque reversing device 6 comprises: a clutch C1 adapted to rotate the input shaft 5 (or the output shaft 5 of the torque converter 3) integrally with an output shaft 7 when brought into engagement during propulsion in the forward direction; and a brake B1 adapted to reverse rotational directions of the input shaft 5 and the output shaft 7 by when brought into engagement during propulsion in the backward direction. In order to interrupt a power transmission between the engine 1 and driving wheels 8 to bring the vehicle into a neutral state, both the clutch C1 and the brake B1 are brought into disengagement.

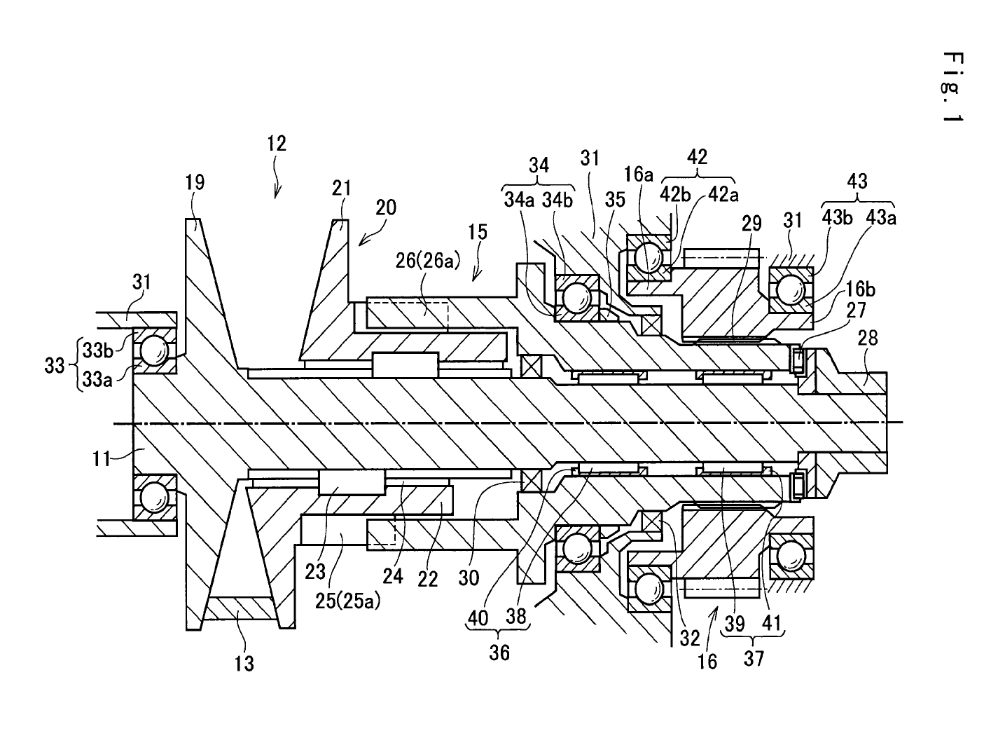

A belt-driven continuously variable transmission 9 (to be abbreviated as the “CVT” 9 hereinafter) is connected to the output shaft 7 of the torque reversing device 6. The CVT 9 shown in FIG. 1 comprises: a primary pulley 10 connected to the output shaft 7 of the torque reversing device 6 (to be also called as the input shaft 7 of the CVT 9); a rotary shaft 11 arranged parallel to the input shaft 7 of the CVT 9; a secondary pulley 12 connected to the rotary shaft 11; and an endless belt 13 running between the pulleys 10 and 12. The primary pulley 10 has a thrust device 14 adapted to alter running radii of the belt 13 by varying width of a groove in the pulley. For example, a hydraulic actuator adapted to hydraulically generate a thrust force, or an electric actuator adapted to electrically generate a thrust force may be used as the thrust device 14. The secondary pulley 12 has a torque cam 15 adapted to generate a thrust force according to an input torque to change a frictional force acting between the belt 13 and each pulley 10 and 12. That is, a torque transmitting capacity of the CVT 9 is changed in accordance with the frictional force acting between the belt 13 and each pulley 10 and 12. An output gear 16 is connected to an output side of the torque cam 15, and torque is transmitted to the drive wheels 8 through the output gear 16, a gear train 17 and a differential gear unit 18.

As described, the shaft supporting structure of the CVT 9 of the present invention is configured to prevent the input shaft 7 and the rotary shaft 11 of the CVT 9 from being flexurally deformed by a tension of the belt 13 running between the pulleys 10 and 12. One example of a structure is illustrated in FIG. 1. Specifically, the torque cam 15 and the output gear 16 arranged concentrically with rotary shaft of the secondary pulley 12 are shown therein. In FIG. 1, an upper side of a rotational center shows the secondary pulley 12 in which the groove width is widened to reduce a speed ratio, and a lower side of the rotational center shows the secondary pulley 12 in which the groove width is narrowed to increase a speed ratio. In the following description, a left side in FIG. 1 will be called as an input side and a right side in FIG. 1 will be called as an output side.

The secondary pulley 12 shown in FIG. 1 comprises a conical fixed sheave 19 integrated with an input side of the rotary shaft 11, and a conical movable sheave 20 splined onto the rotary shaft 11 to be rotated integrally therewith while being allowed to reciprocate in an axial direction. Specifically, the movable sheave 20 comprises a conical sheave 21 to which torque is transmitted from the belt 13 contacted thereto, and a cylindrical boss portion 22 extending from a rotational center side of the conical sheave 21 toward an output side. The boss portion 22 of the conical sheave 21 is splined onto the rotary shaft 11 to be rotated integrally therewith through a connection mechanism 23 such as a spline and a key. The torque cam 15 is adapted to push the movable sheave 20 toward the fixed sheave 19 in accordance with the torque applied to the movable sheave 20. Thus, in the secondary pulley 12 shown in FIG. 1, the torque inputted from the belt 13 to the fixed sheave 19 is transmitted to the movable sheave 20 through the connection mechanism 23. That is, total torque transmitted from the belt 13 to the fixed sheave 19 and the movable sheave 20 is transmitted to the torque cam 15. In addition, the boss portion 22 is provided with a bush 24 so as to reduce axial sliding resistance between an outer circumferential face of the rotary shaft 11 and an inner circumferential face of the boss portion 22.

The torque cam 15 is formed into a cylindrical shape to be fitted onto the outer face of the boss portion 22. The torque cam 15 is adapted not only to transmit the torque from the movable sheave 20 to the output side but also to apply a thrust force to the movable sheave 20 in accordance with an input torque. To this end, a plurality of depressions 25 is formed on an outer circumferential face of the conical sheave 21 side of the boss portion 22 at predetermined intervals in a circumferential direction, each depression 25 has an inclined side face to be called as the inclined face 25a hereinafter. A plurality of protrusions 26 is formed on an end portion of an input side of the torque cam 15 at predetermined intervals in an circumferential direction to be contacted to the inclined face 25a to transmit torque. A side face of each protrusion 26 is also inclined at the same angle with the inclined face 25a, and will be called as the inclined face 26a hereinafter. A leading end portion of the protrusion 26 will not come into contact to a bottom portion of the depression 25 even if the movable sheave 21 is moved to the most input side to establish a minimum speed ratio. In order not to cause a slippage between the belt 13 and the pulley 12 even when an expected maximum torque is applied to the torque cam 15, inclination angles of the inclined faces are determined based on an expected thrust force applied to the movable sheave 20 and an expected maximum torque to the torque cam 15.

The inclined face 25a of the depression 25 of the movable sheave 20 is thus brought into contact to the inclined face 26a of the protrusion 26 of the torque cam 15 so that the torque cam 15 is pushed in the axial direction toward the output side when the torque is transmitted from the movable sheave 20 to the torque cam 15. In order to restrict such an axial movement of the torque cam 15 toward the output side, a nut 28 as a stopper is fixed to an output end of the rotary shaft 11. The torque cam 15 is allowed to rotate relatively with respect to the movable sheave 20 with a change in the speed ratio of the CVT 19. Consequently, the nut 28 on the rotary shaft 11 and the torque cam 15 are rotated relatively with each other. In order to reduce sliding resistance between the nut 28 and the torque cam 15, a thrust bearing 27 is disposed between an output end of the torque cam 15 and the nut 28. An outer diameter of the output side of the torque cam 15 is smaller than that of the input side thereof. In addition, the output gear 16 as an external gear serving as the claimed output member is fitted onto the output side of the torque cam 15. Specifically, an outer circumferential face of diametrically reduced portion of output side of the torque cam 15 is splined to an inner circumferential face of the output gear 16. A site where the torque cam 15 and the output gear 16 are brought into engagement will be called as a splined portion 29 in the following description.

The CVT 9 shown in FIG. 6 is a dry-type belt driven continuously variable transmission in which lubrication oil is not applied to a contact site between the belt 13 and the pulley face. That is, the input side where the secondary pulley 12 shown in FIG. 1 is situated is maintained to a dry condition, and an intrusion of the lubrication oil applied to the output gear 16 etc. into the secondary pulley 12 side is prevented. For this purpose, in the example shown in FIG. 1, a sealing member 30 such as an O ring is interposed between an inner face of a center portion of the torque cam 15 and an outer circumferential face of the rotary shaft 11. In addition, a sealing member 32 such as an O ring is also interposed between the outer face of the torque cam 15 and a casing 31. Specifically, the sealing member 32 is fitted onto the torque cam 15 at a portion of input side of the connection site between the torque cam 15 and the output gear 16 where a diameter of the torque cam 15 is increased. Therefore, the lubrication oil is allowed to be flown into a space of output side of the sealing members 30 and 32 where the member has to be lubricated such as the output gear 16 is situated, but prevented from entering into the space of input side of the sealing members 30 and 32 where the secondary pulley 12 is situated.

The movable sheave 20 is moved in the axial direction of the rotary shaft 11 relatively to/from the torque cam 15 by changing a speed ratio. In order to reduce a frictional loss between the inclined faces 25a and 26a, a chip made of carbon material is attached to a side face of the protrusion 26 of the torque cam 15. In addition, a spline 23 connecting the movable sheave 20 to the rotary shaft 11, and a bush 24 interposed therebetween are covered by resin material.

Next, a structure for supporting each rotary shaft shown in FIG. 1 will be explained hereafter. An end portion of input side of the rotary shaft 11 is supported rotatably by a first ball bearing 33 fixed to the casing 31. The first ball bearing 33 is fitted onto the end portion of input side of the rotary shaft 11 in such a manner that a side face of an inner race 33a is brought into is contact to an inner circumferential portion of a back face of the fixed sheave 19. A second ball bearing 34 is fitted rotatably onto the torque cam 15 at the center portion. Specifically, an outer race 34b of the second ball bearing 34 is fixed to the casing 31, and an inner race 34a is held between a stopper portion formed on output side of a diametrically largest portion and a nut 35 in such a manner to rotate integrally with the torque cam 15. Thus, the second ball bearing 34 is disposed on input side of the sealing member 32. That is, both the ball bearings 33 and 34 are arranged in the space kept to dry condition to which the lubrication oil is not applied. Therefore, lubricant is encapsulated between the inner race 33a and the outer race 33b of the bearing 33, and between the inner race 34a and the outer race 34b of the bearing 34.

When changing a speed ratio, a sliding motion of the inclined face 26a of the protrusion 26 of the torque cam 15 along the inclined face 25a of the depression 25 of the movable sheave 20 is converted into a relative rotation of the torque cam 15 with respect to the movable sheave 20. However, as described, the movable sheave 20 is splined onto the rotary shaft 11 through the spline 23 to be rotated integrally therewith. In order to enable a relative rotation between the torque cam 15 and the rotary shaft 11 during changing a speed ratio, two roller bearings 36 and 37 serving as the claimed first bearing, third bearing and fourth bearing are disposed between the inner face of the torque cam 15 and the outer face of the rotary shaft 11 in the output side of the sealing member 30 while keeping predetermined interval therebetween. Specifically, in the first roller bearing 36 and the second roller bearing 37, a plurality of rollers 38 (39) disposed on the outer face of the rotary shaft 11 circumferentially at predetermined intervals are held rotatably by a cover 40 (41) fixed to the inner face of the torque cam 15. The first roller bearing 36 is axially overlapped with the second ball bearing 34 and the nut 35, and the second roller bearing 37 is axially overlapped with the splined portion 29 or external teeth of the output gear 16. In addition, the first roller bearing 36, the sealing member 32 and an after-mentioned third ball bearing 42 are partially overlapped to each other in the axial direction.

As described, in the example shown in FIG. 1, two roller bearings 36 and 37 are interposed between the torque cam 15 and the rotary shaft 11 to enable a relative rotation therebetween, but the bearings 36 and 37 are subjected to radial loads from the torque cam 15 and the rotary shaft 11. Here, the number of those roller bearings may be changed arbitrarily. For example, a single bearing having a length longer than a length from the first roller bearing 36 to the second roller bearing 37 may be employed instead of the roller bearings 36 and 37 to reduce the number of the roller bearings. By contrast, more than three roller bearings may also be used according to need.

As mentioned above, the output gear 16 is connected to the torque cam 15 through the splined portion 29, and both input and output sides of the splined portion 29 in the axial direction are held rotatably by a third ball bearing 42 and a fourth ball bearing 43. Specifically, a cylindrical portion 16a protruding toward the input side is formed on the outer circumferential side of the output gear 16. An inner race 42a of the third ball bearing 42 is fixed to an outer face of the cylindrical portion 16a, and an outer race 42b of the third ball bearing 42 is fixed to the casing 31. On the other hand, a cylindrical portion 16b protruding toward the output side is formed on the inner circumferential side of the output gear 16. An inner race 43a of the fourth ball bearing 43 is fixed to an outer face of the cylindrical portion 16b, and an outer race 43b of the fourth ball bearing 43 is fixed to the casing 31. Thus, since the cylindrical portion 16a protrudes from the outer circumferential side toward the input side, the sealing member 32 may be held in a space created between the inner face of the cylindrical portion 16a and outer face of the torque cam 15. As also described, the first roller bearing 36 is arranged in such a manner to be overlapped with the inner circumferential face of the third ball bearing 42 in the axial direction. Here, the third ball bearing 42 serves as the claimed second bearing.

As described, in the example shown in FIG. 1, the movable sheave 20 is fitted onto the rotary shaft 11 through the bush 24, and the torque cam 15 is also fitted onto the rotary shaft 11 through the roller bearings 36 and 37. This means that the rotary shaft 11, the movable sheave 20 and the torque cam 15 form a unified rotary shaft. That is, in the example shown in FIG. 1, the unified rotary shaft thus formed by the rotary shaft 11, the movable sheave 20 and the torque cam 15 is supported by the first ball bearing 33 and the second ball bearing 34. In the following description, the rotary shaft thus formed by the rotary shaft 11, the movable sheave 20 and the torque cam 15 will be called as the “shaft assembly S”.

In the example shown in FIG. 1, the shaft assembly S may be deflected between the first and the second ball bearings 33 and 34 by a load applied from the belt 13. That is, when a load is applied to a portion of the shaft assembly S between the first and the second ball bearings 33 and 34, a portion of the shaft assembly S in the output side of the first bearing 34 as a support point is deflected in a direction opposite to a direction of the load. Specifically, if a load is applied to the shaft assembly S from a lower side in FIG. 1, the portion of the shaft assembly S between the first and the second ball bearings 33 and 34 is curved into arcuate thereby displacing a portion of the shaft assembly S in the output side of the first bearing 34 downwardly. If a length between the second ball bearing 34 and the output gear 16 is long, the output gear 16 is displaced significantly. In this case, a rattling noise and vibrations of the output gear 16 would be generated, and in addition a power loss may be increased.

In order to avoid such disadvantages, in the shaft supporting structure of the present invention, the cylindrical portion 16a on which the third ball bearing 42 is fitted is protruded toward the input side, and the sealing member 32 is disposed in the inner circumferential side of the cylindrical portion 16a. In the shaft supporting structure, therefore, the output gear 16 can be situated closer to the second ball bearing 34 to shorten the distance between the output gear 16 and the second ball bearing 34. For this reason, the displacement of the shaft assembly S at a site on which the output gear 16 is fitted can be reduced. In addition, a total length of the shaft assembly S may also be reduced, and hence the CVT 9 can be downsized in a width direction. Further, since the splined portion 29 and the second roller bearing 37 are overlapped in the axial direction, the total length of the shaft assembly S can be further reduced so that the CVT 9 can be further downsized.

The sealing member 32 is arranged between the rotatable torque cam 15 and the fixed casing 31 so that either one of an inner circumferential face or an outer circumferential face of the sealing member 32 can rotate relatively with respect to the torque cam 15 or the casing 31. Therefore, a relative circumferential velocity of the sealing member 32 can be reduced to reduce a damage thereof by thus arranging the sealing member 32 close to the rotational center.

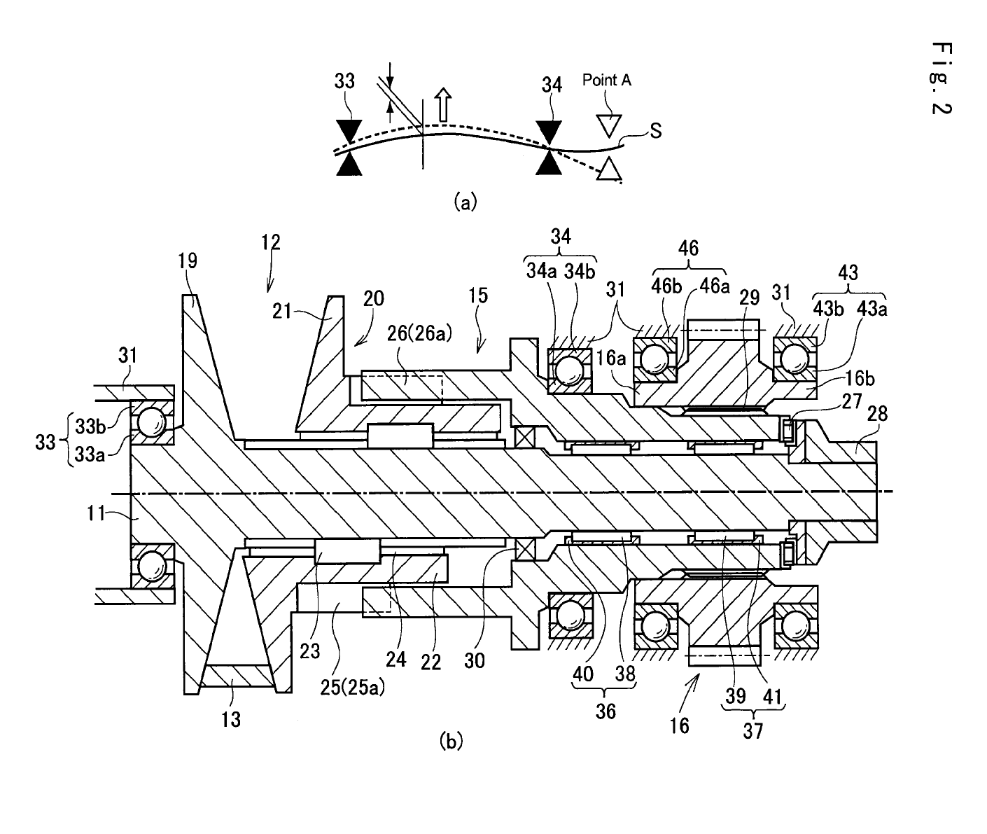

Next, a structure for suppressing the flexural deformation between the first ball bearing 33 and the second ball bearing 34 will be described hereafter. FIG. 2(a) is a schematic illustration showing a situation where the shaft assembly S is deflected by a load transmitted of the belt 13. As described, the shaft assembly S is supported rotatably by the first ball bearing 33 and the second ball bearing 34. Therefore, when an upward load is applied to the shaft assembly S from the belt 13, the shaft assembly S is deflected as indicated by a dashed line in FIG. 2(a). In order to reduce deflection of the shaft assembly S between the first ball bearing 33 and the second ball bearing 34, according to the example shown in FIG. 2, displacement of the portion of the shaft assembly S in the output side of the second ball bearing 34 is restricted. Specifically, the deflection of the shaft assembly S is restricted at a point A in FIG. 2 (a). A solid lined in FIG. 2 (a) represents one example of deflection of the shaft assembly S under a condition that the portion of output side of the second ball bearing 34 is restricted at the point A.

The displacement of the output side of the second ball bearing 34 can be restricted by reducing a clearance of the splined portion 29 in FIG. 1. A displacement of the splined portion 29 may be calculated based on: a displacement between the ball bearings 33 and 34 calculated based on a load applied from the belt 13 to the shaft assembly S when the CVT 19 transmits a maximum torque, or a strength or a structure of the shaft assembly S; a distance between a site to which the load is applied and the ball bearing 34; a displacement at the site to which the load is applied; and a distance between the second ball bearing 34 and the splined portion 29.

That is, the clearance of the splined portion 29, i.e., the clearance between the outer circumferential face of the torque cam 15 and the inner circumferential face of the output gear 16, is adjusted to be smaller than the displacement calculated by the above-explained procedure. Therefore, even when a load is applied from the belt 13 to the shaft assembly S, displacement of the portion of the shaft assembly S of output side of the second ball bearing 34 is restricted within the clearance of the splined portion 29 so that the displacement between the first and the second ball bearings 33 and 34 can be suppressed. In other words, as illustrated in FIG. 2(b), the displacement of the portion of the shaft assembly S of output side of the second ball bearing 34 can be restricted by thus reducing the clearance between the inner circumferential face of the cylindrical portion 16a of the output gear 16 and the outer circumferential face of the torque cam 15 to expedite a contact therebetween. Accordingly, the splined portion 29 serves as the claimed engaged portion. In FIG. 2(b), the sealing member 32 is not employed, and a bearing for supporting the output gear 16 is indicated as a fifth ball bearing 46.

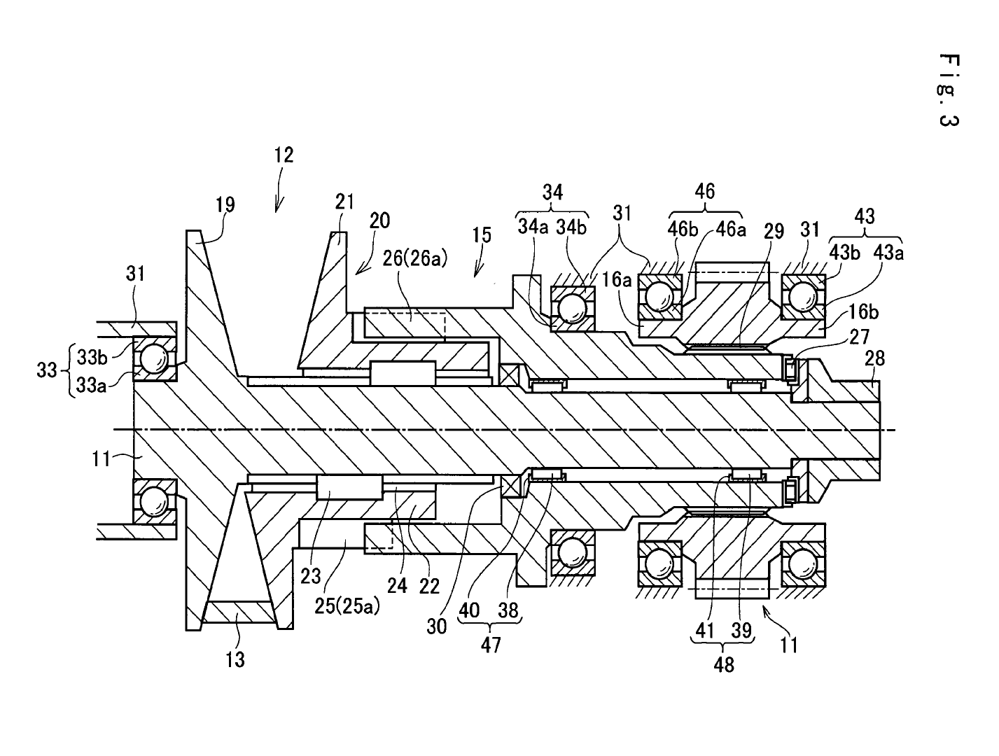

Turning to FIG. 3, there is shown another example of the shaft supporting structure of the CVT 19 according to the present invention. In FIG. 3, common reference numerals are allotted to the elements in common with those in the example shown in FIG. 1, and detailed explanation for those common elements will be omitted. In the example shown in FIG. 3, a third roller bearing 47 is interposed between the rotary shaft 11 and the torque cam 15 in the input side of the second ball bearing 34 in the axial direction. In the example shown in FIG. 3, the remaining elements are similar to those of the example shown in FIG. 1, and the roller bearing 48 arranged in the input side between the rotary shaft 11 and the torque cam 15 will be called as a fourth roller bearing 48. Here, the first ball bearing 33, the second ball bearing 34, the third roller bearing 47 and the fourth roller bearing 48 serve as the claimed sixth bearing, seventh bearing, eight bearing and ninth bearing, respectively.

In the example shown in FIG. 3, an engaged portion between the torque cam 15 and the rotary shaft 11 through the roller bearing is partially situated between the ball bearings 33 and 34 supporting the shaft assembly S to improve flexural strength of the shaft assembly S between the ball bearings 33 and 34. Specifically, the third roller bearing 47 is situated in the input side of the second ball bearing 34. Since the rotary shaft 11 is thus integrated with the torque cam 15 through the third and fourth roller bearings 47 and 48, a second moment of area of the shaft assembly S between the third and the fourth roller bearings 47 and 48 is increased. The portion where the second moment of area is thus increased is supported by the second ball bearing 34 to be prevented from being deformed flexurally by the load applied from the belt 13, so that deformation of the shaft assembly S between the first and the second ball bearings 33 and 34 can be suppressed. That is, the flexural deformation of the shaft assembly S can be reduced.

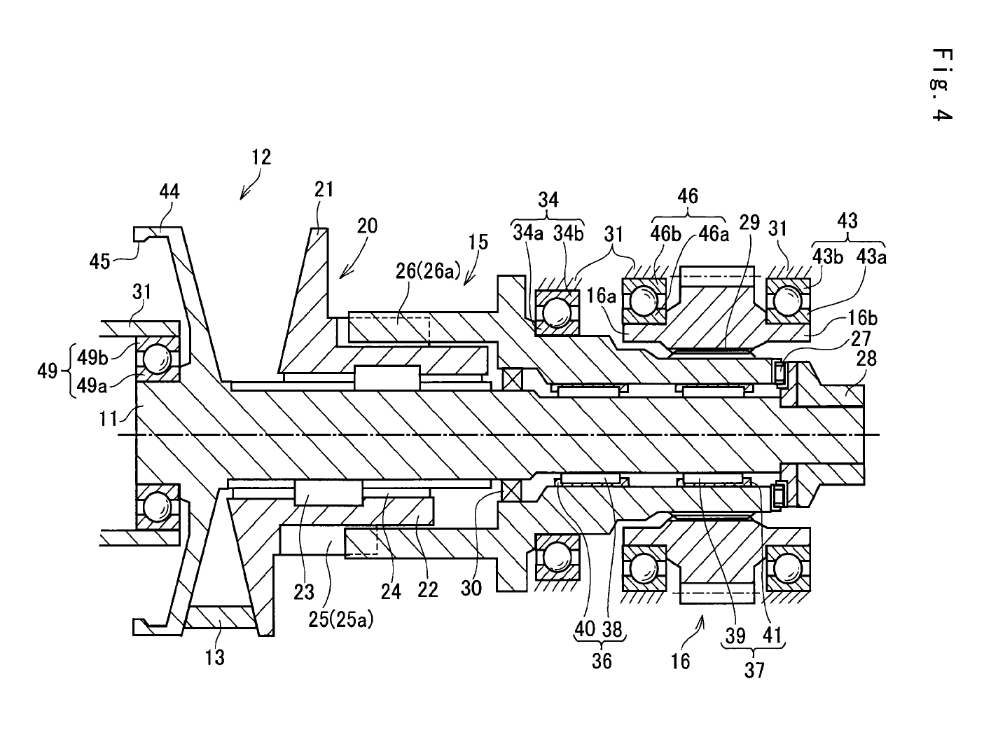

Next, an example of the structure to suppress the flexural deformation of the shaft assembly S by reducing a length of the shaft assembly S and a moment derived from the load of the belt 13 applied to the shaft assembly S will be explained with reference to FIG. 4. A structure of the example shown in FIG. 4 is similar to those of the examples shown in FIGS. 1 to 3 except for the fixed sheave 19. In the example shown in FIG. 4, specifically, the fixed sheave 19 has an inward conical face on the opposite side of the pulley face. That is, the back face of the fixed sheave 19 is depressed inwardly, and a thickness of the inward conical face is substantially constant. A cylindrical portion 44 protruding toward the back side is formed along an outer circumferential edge of the fixed sheave 19, and an inner rim 45 is formed along on an opening end of the cylindrical portion 44. In this example, a bearing 49 for supporting the rotary shaft 11 is held inside of the cylindrical portion 44. The space thus creased in the back side of the fixed sheave 19 by depressing the back side toward the belt 13 serves as the claimed depression.

According to the example shown in FIG. 4, a distance between a point at which a load is applied from the belt 13 to the shaft assembly S and the sixth ball bearing 49 can be reduced by thus forming the inward conical face on the opposite side of the pulley face of the fixed sheave 19. In other words, the sixth ball bearing 49 can be arranged closer to the second ball bearing 34. As a result, a moment applied to the shaft assembly S can be reduced thereby improving the flexural strength of the shaft assembly S, i.e., reducing the deformation of the shaft assembly S. In addition, since the cylindrical portion 44 is situated on an outer circumferential side of the sixth ball bearing 49, the lubricant can be prevented from being centrifugally scattered toward an outer circumferential side even if a leakage of lubricant in the sixth ball bearing 49 occurs. For example, the groove width of the primary pulley 10 is widened as shown in FIG. 1 when increasing the speed ratio. In this situation, although not especially illustrated, the pulley face of the primary pulley 10 will be situated in an outer circumferential side of the sixth ball bearing 49. According to the example shown in FIG. 4, however, the cylindrical portion 44 is formed in the back side of the fixed sheave 19 so that the lubricant leaking from the sixth ball bearing 49 can be blocked by the cylindrical portion 44 to prevent the pulley face of the primary pulley 10 from being contaminated by the lubricant. Thus, scattering of the lubricant toward outer circumferential side can be prevented by the rim 45 formed on the opening of the cylindrical portion 44.

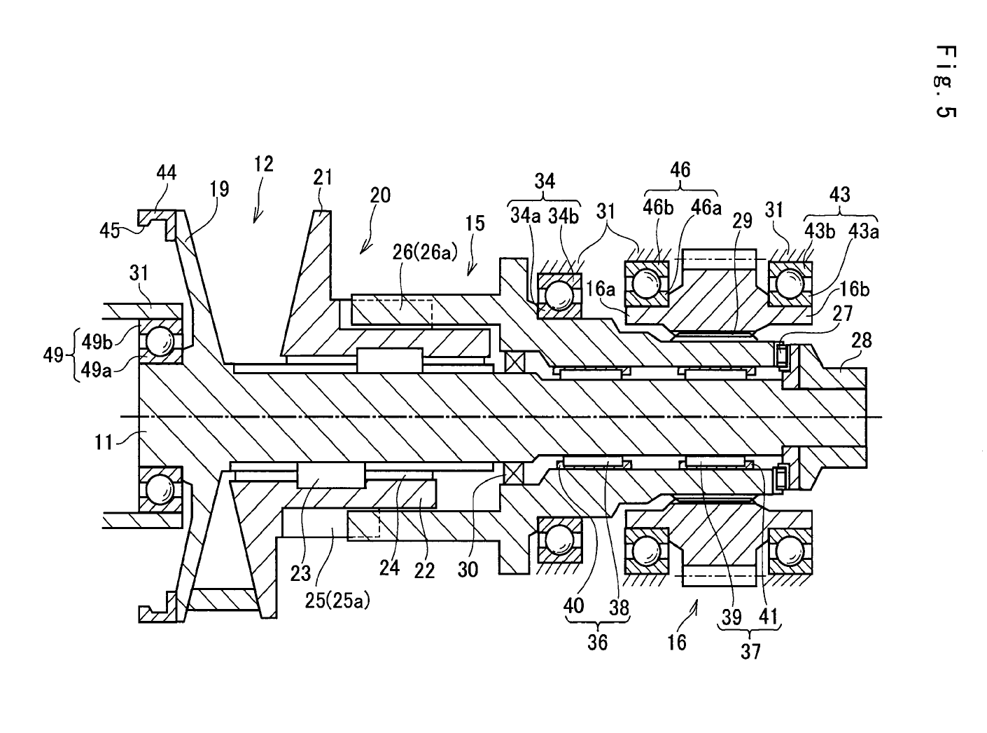

Optionally, the cylindrical portion 44 and the rim 45 may be formed not only integrally with the fixed sheave 19 but also separately to be attached to the fixed sheave 19 as illustrated in FIG. 5. Both of the cylindrical portion 44 formed integrally with the fixed sheave 19 and the cylindrical portion 44 formed separately from the cylindrical portion 44 as the example shown in FIG. 5 correspond to the claimed first cylindrical portion or the claimed second cylindrical portion. The sixth ball bearing 49 arranged in the inner circumferential side of the cylindrical portion 44 as shown in FIGS. 4 and 5 corresponds to the claimed fifth bearing and the claimed sixth bearing.

The shaft supporting structure shown in FIGS. 4 and 5 may be combined arbitrarily. In the foregoing examples, the movable sheave 20 is connected to the rotary shaft 11 through the connection mechanism 23 such as the spline. However, structure of the connection mechanism 23 should not be limited to any specific structure as long as the fixed sheave 20 is allowed to slide on the rotary shaft 11. In addition, the present invention may also be applied to a rotary shaft connected to the primary pulley 10.

1. A shaft supporting structure of a belt-driven continuously variable transmission, comprising:
a pulley comprising a fixed sheave integrated with a rotary shaft, and a movable sheave fitted onto the rotary shaft while being allowed to reciprocate in an axial direction;
a belt running on the pulley;
a torque cam fitted onto the rotary shaft on a back side of the movable sheave while being allowed to rotate relatively therewith to generate an axial thrust force in accordance with a torque applied thereto;
an output member fitted onto the torque cam in such a manner to be rotated integrally with the torque cam;
at least one first bearing interposed between an outer circumferential face of the rotary shaft and an inner circumferential face of the torque cam to support those members while allowing relative rotation therebetween;
a second bearing that is situated radially outside of the first bearing to support one of axial ends of the output member while allowing the output member to rotate relatively with a casing; and
a sealing member fitted onto the torque cam to be interposed between an outer circumferential face of the torque cam and the second bearing.

2. The shaft supporting structure of a belt-driven continuously variable transmission as claimed in claim 1,
wherein the first bearing includes a third bearing and a fourth bearing arranged coaxially in series, and
wherein any one of the third bearing and the fourth bearing is overlapped with the output member in the axial direction.

3. The shaft supporting structure of a belt-driven continuously variable transmission as claimed in claim 1,
wherein the fixed sheave includes a depression in a back face of a pulley face contacted to the belt in which a most inner circumferential side is depressed toward the belt deeper than an outer circumferential side, and a first cylindrical portion that protrudes from the back face in the axially opposite direction to the belt; and
further comprising a fifth bearing situated in an inner circumferential side of the first cylindrical portion while allowing the rotary shaft to rotate relatively with the casing.

4. The shaft supporting structure of a belt-driven continuously variable transmission, comprising:
a pulley comprising a fixed sheave integrated with a rotary shaft, and a movable sheave fitted onto the rotary shaft while being allowed to reciprocate in an axial direction;
a belt running on the pulley;
a torque cam fitted onto the rotary shaft on a back side of the movable sheave while being allowed to rotate relatively therewith to generate an axial thrust force in accordance with a torque applied thereto;
an output member fitted onto the torque cam in such a manner to be rotated integrally with the torque cam;
a sixth bearing supporting an end portion of the rotary shaft of the fixed sheave side while allowing the rotary shaft to rotate relatively with the casing;
a seventh bearing fitted onto the torque cam to allow the torque cam to rotate relatively with the casing; and
at least an eighth bearing and a ninth bearing interposed between an inner circumferential face of the torque cam and an outer circumferential face of the rotary shaft to support those members while allowing relative rotation therebetween;
wherein the eighth bearing is disposed between the sixth bearing and the seventh bearing in the axial direction, and the ninth bearing is disposed on an opposite side of the eighth bearing in the axial direction across the seventh bearing.

5. The shaft supporting structure of a belt-driven continuously variable transmission as claimed in claim 4, wherein the eighth bearing is overlapped with the output member in the axial direction.

6. The shaft supporting structure of a belt-driven continuously variable transmission as claimed in claim 4,
wherein the fixed sheave includes a depression in a back face of a pulley face contacted to the belt in which a most inner circumferential side is depressed toward the belt deeper than an outer circumferential side, and a second cylindrical portion that protrudes from the back face in the axially opposite direction to the belt; and
further comprising a sixth bearing situated on an inner circumferential side of the second cylindrical portion.

7. The shaft supporting structure of a belt-driven continuously variable transmission as claimed in claim 1, further comprising:
an engaged portion that restricts the deformation of the torque cam in a radial direction.

8. The shaft supporting structure of a belt-driven continuously variable transmission as claimed in claim 2,
wherein the fixed sheave includes a depression in a back face of a pulley face contacted to the belt in which a most inner circumferential side is depressed toward the belt deeper than an outer circumferential side, and a first cylindrical portion that protrudes from the back face in the axially opposite direction to the belt; and
further comprising a fifth bearing situated in an inner circumferential side of the first cylindrical portion while allowing the rotary shaft to rotate relatively with the casing.

9. The shaft supporting structure of a belt-driven continuously variable transmission as claimed in claim 5,
wherein the fixed sheave includes a depression in a back face of a pulley face contacted to the belt in which a most inner circumferential side is depressed toward the belt deeper than an outer circumferential side, and a second cylindrical portion that protrudes from the back face in the axially opposite direction to the belt; and
further comprising a sixth bearing situated on an inner circumferential side of the second cylindrical portion.

10. The shaft supporting structure of a belt-driven continuously variable transmission as claimed in claim 4, further comprising:
an engaged portion that restricts the deformation of the torque cam in a radial direction.
